(19) United States
(12) Patent Application Publication
(10) Pub. No.: US 2026/0058252 A1
(43) Pub. Date: Feb. 26, 2026

(54) METHOD FOR CHARGING AN ENERGY STORAGE SYSTEM OF AN ELECTRIC VEHICLE

(71) Applicant: Ampcera Inc., Milpitas, CA (US)

(72) Inventors: James Emery Brown, Tucson, AZ (US); Hui Du, Tucson, AZ (US); Sumin Zhu, Tucson, AZ (US)

(73) Assignee: Ampcera Inc., Milpitas, CA (US)

(21) Appl. No.: 18/813,121

(22) Filed: Aug. 23, 2024

(51) Int. Cl. H01M 10/657; B60L 1/08; B60L 53/60; B60L 58/27; H01M 10/615; H01M 10/625

(52) U.S. Cl. CPC H01M 10/657; B60L 1/08; B60L 53/60; B60L 58/27; H01M 10/615; H01M 10/625; B60L 2240/545

(57) ABSTRACT

A method for charging an energy storage system of an electric vehicle using a charging station equipped with an electrical power supply and an electromagnetic wave generator, the method comprising: connecting the charging station to an electric vehicle; determining a frequency at which a dielectric loss of the energy storage system is above a predetermined threshold; applying electromagnetic wave energy at the determined frequency from the electromagnetic wave generator of the charging station to current collectors of the energy storage system to dielectrically heat the energy storage system to a temperature suitable for charging; and applying electrical power to the current collectors of the heated energy storage system to charge the energy storage system.

### FIELD

The present application relates to the field of charging methods for electric vehicles.

### BACKGROUND

Electric vehicles (EVs) have seen significant growth in adoption due to their potential to reduce greenhouse gas emissions, dependence on fossil fuels, and urban air pollution. A key component of EV technology is the energy storage system, typically a battery, which powers the vehicle.

Traditional methods for charging EV batteries primarily involve connecting the vehicle to a charging station that supplies electrical power to the battery's current collectors. These charging stations can be equipped with either alternating current (AC) or direct current (DC) power supplies. DC fast charging stations, in particular, are known for their ability to charge batteries at a much faster rate compared to AC charging stations.

Various types of batteries are used in electric vehicles, including lithium-ion, nickel-metal hydride, and lead-acid batteries. Each type of battery has its unique characteristics and requirements for optimal charging. For instance, lithium-ion batteries, commonly used in modern EVs, require precise management of voltage and temperature during the charging process to ensure safety and efficiency.

EV charging systems typically include components such as power converters, controllers, sensors, and cooling systems. The battery management system (BMS) plays a crucial role in monitoring and controlling the charging process, ensuring that the battery operates within safe temperature and voltage ranges. The BMS can communicate with the charging station to regulate the charging parameters based on the battery's state of charge (SOC) and state of health (SOH).

In colder climates, the performance of EV batteries can be adversely affected, leading to longer charging times and reduced efficiency. To mitigate these issues, some EVs are equipped with thermal management systems that preheat the battery to an optimal temperature before charging begins.

As the demand for electric vehicles continues to grow, there is ongoing research and development in the field of EV charging methods to improve charging speed, efficiency, and overall battery performance.

Accordingly, those skilled in the art continue with research and development in the field of charging methods for electric vehicles.

### SUMMARY

In one embodiment, there is a method for charging an energy storage system of an electric vehicle.

In an example, the method uses a charging station equipped with an electrical power supply and an electromagnetic wave generator, the method comprising: connecting the charging station to an electric vehicle; determining a frequency at which a dielectric loss of the energy storage system is above a predetermined threshold; applying electromagnetic wave energy at the determined frequency from the electromagnetic wave generator of the charging station to current collectors of the energy storage system to dielectrically heat the energy storage system to a temperature suitable for charging; and applying electrical power to the current collectors of the heated energy storage system to charge the energy storage system.

Other embodiments of the disclosed method will become apparent from the following detailed description, the accompanying drawings and the appended claims.

### BRIEF DESCRIPTION OF THE DRAWINGS

FIG. 1 is a flow diagram of an exemplary method of charging of the present description.

### DETAILED DESCRIPTION

The following detailed description, with reference to the accompanying figures, illustrates various aspects and embodiments of a method for charging an energy storage system of an electric vehicle using a charging station equipped with an electromagnetic wave generator. The description is not intended to be exhaustive or to limit the scope of the disclosure to the precise form disclosed. It is to be understood that other embodiments may be utilized and that logical, mechanical, electrical, and other changes may be made without departing from the scope of the disclosure. Therefore, specific structural and functional details disclosed herein are not to be interpreted as limiting, but merely as a representative basis.

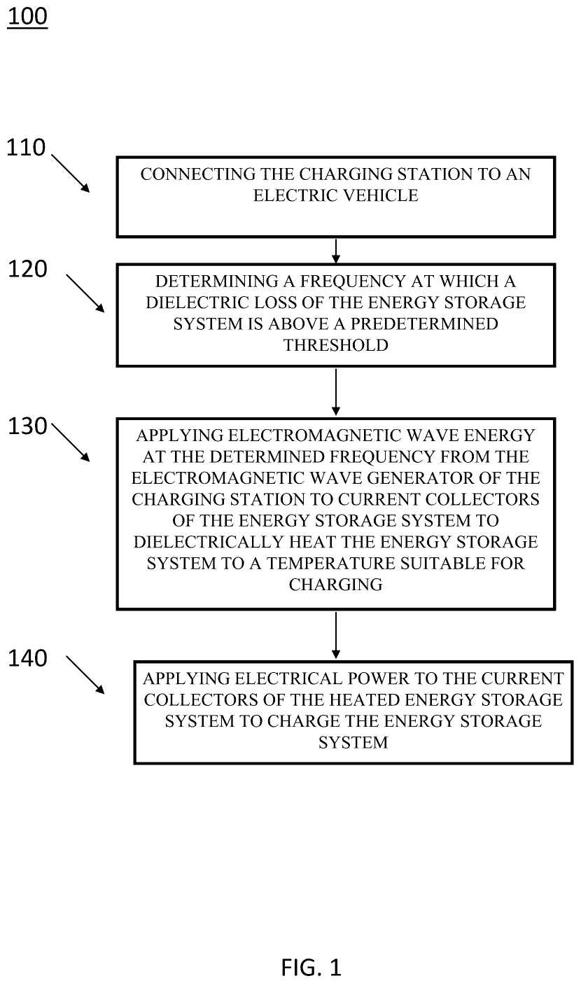

Referring to FIG. 1, the present description relates to method 100 for charging an energy storage system of an electric vehicle using a charging station equipped with an electrical power supply and an electromagnetic wave generator. The method includes: at block 110, connecting the charging station to an electric vehicle; at block 120, determining a frequency at which a dielectric loss of the energy storage system is above a predetermined threshold; at block 130, applying electromagnetic wave energy at the determined frequency from the electromagnetic wave generator of the charging station to current collectors of the energy storage system to dielectrically heat the energy storage system to a temperature suitable for charging; and at block 140, applying electrical power to the current collectors of the heated energy storage system to charge the energy storage system. By utilizing a charging station equipped with an electromagnetic wave generator, the method significantly enhances charging efficiency, reduces energy loss, and improves overall performance of the energy storage system. According to this approach, EVs can achieve better charging outcomes, leading to increased reliability, extended storage system life, and a more sustainable transportation solution.

Electric Vehicles: Electric vehicles (EVs) relevant to the present method of charging encompass a broad range of vehicles equipped with energy storage systems that can connect to an external charging station. These EVs can rely on various energy storage technologies, which may include batteries or other types of energy storage systems. Types of vehicles include bicycles, scooters, motorcycles, cars, trucks, buses, vans, trains, trams, boats, and aircraft. Typical EVs include vehicles solely powered by an electric battery and vehicles powered by a combination of an electric battery with another power source, such as an internal combustion engine (ICE). The described dielectric heating method involves using electromagnetic wave energy to preheat the energy storage system of the electric vehicle, enhancing the charging process by increasing the temperature to an optimal level for efficient energy transfer. This method is particularly beneficial for EVs operating in cold climates, where energy storage performance typically declines.

### Electric Vehicle Components

Energy Storage Systems: The energy storage system is a device or a set of devices that can store and release energy as needed to power an electric vehicle, either alone or in combination with another power source. An energy storage system includes one or more energy storage units, such as electrochemical cells. The energy storage system also includes current collectors, which are conductive materials that connect the energy storage units to the external circuit and allow the flow of electric current. The energy storage system may also include other components, such as power converters, controllers, sensors, cooling systems, and protective devices.

In the description below, the energy storage system will be described in the context of a battery including a plurality of electrochemical cells, but it will be understood that the principle of the present description is not limited to this specific configuration and can be applied to any type of energy storage system that can benefit from dielectric heating. The energy storage system may have various shapes, sizes, arrangements, and configurations, depending on the design and requirements of the electric vehicle. The number, type, and characteristics of the electrochemical cells may also vary, depending on the desired capacity, voltage, power, and performance of the battery. The components of the energy storage system may also different configurations and functions, depending on the operational needs of the electric vehicle. Therefore, the following description is intended to illustrate the general concept and the possible embodiments of the present method of charging, without limiting its scope or applicability.

Electric Vehicle Components: An electric vehicle includes several components that enable its operation and performance. Some of the typical components of an electric vehicle are:

Electrochemical Cells: Electrochemical cells are the basic units of a battery, where the electrochemical reactions take place. An electrochemical cell includes electrodes (anode and cathode) and an electrolyte that separates them and allows the ion transport. Electrochemical cells are classified into primary or secondary, depending on whether it is rechargeable or not. Primary cells are designed to be used once and then discarded, while secondary cells can be recharged by reversing the electrochemical reaction. Some examples of secondary cells suitable for electric vehicle batteries are: lead-acid, nickel-cadmium, nickel-metal hydride, lithium-ion, lithium-polymer, lithium-sulfur, sodium-ion, sodium-sulfur, and metal-air. Some other possible secondary cells suitable for electric vehicle batteries are: lithium-air, lithium-selenium, magnesium-sulfur, potassium-ion, potassium-sulfur, calcium-ion, and zinc-bromine.

Anode (Negative Electrode): The anode is a secondary battery cell's negative electrode where a reduction process occurs during charging. The anode accepts electrons from the external circuit which reduces positive ions from the electrolyte. A reverse oxidation occurs during the discharge process where the positive ions are released back to the electrolyte while electrons are released to the external circuit. An example includes a lithium-ion battery wherein during charging an intercalation process occurs where the anode accepts electrons from the external circuit which reduces the positive lithium ions from the electrolyte. During discharge, a deintercalation occurs where lithium ions are released back to the electrolyte, and electrons are released to the external circuit. Different types of batteries use various materials for the anode, depending on their chemical reactions and performance characteristics. Some possible anodes suitable for electric vehicle batteries are: silicon, graphite, carbon nanotubes, carbon fibers, carbon black, activated carbon, hard carbon, lithium metal or alloy, lanthanum-nickel alloy, titanium-nickel alloy, lead, lead oxide, polymer-ceramic composites, silicon-carbon composites, and silicon-based alloys. Some other possible anodes suitable for electric vehicle batteries are: aluminum, tin, zinc, magnesium, antimony, phosphorus, or their alloys and composites.

Cathode (Positive Electrode): The cathode is a secondary battery cell's positive electrode where an oxidation process occurs during charging. The cathode releases electrons to the external circuit and positive ions to the electrolyte. A reverse reduction occurs during the discharge process where the cathode accepts electrons from the external circuit which reduces positive ions from the electrolyte. An example includes a lithium-ion battery wherein during charging a deintercalation process occurs where electrons are released to the external circuit and lithium ions to the electrolyte. During discharge, an intercalation process occurs where electrons are accepted from the external circuit which reduces the lithium ions from the electrolyte. Different types of batteries use various materials for the cathode, depending on their chemical reactions and performance characteristics. Some possible cathodes suitable for electric vehicle batteries are: lithium cobalt oxide, lithium manganese oxide, lithium nickel manganese cobalt oxide, lithium iron phosphate, lithium nickel cobalt aluminum oxide, lithium titanate, manganese dioxide, nickel-cadmium, nickel-metal hydride, nickel-iron, nickel-zinc, silver-zinc, lead dioxide, polymer-ceramic composites, carbon-sulfur composites, and lithium-sulfur. Some other possible cathodes suitable for electric vehicle batteries are: sodium cobalt oxide, sodium manganese oxide, sodium iron phosphate, sodium nickel chloride, sodium-ion sulfide, aluminum-air, magnesium-air, zinc-air, or their alloys and composites.

Electrolyte: The electrolyte is the medium that allows electron transfer between the anode and the cathode in a battery. The electrolyte contains ions that react with the electrodes and conduct ions. Different types of batteries use various materials for the electrolyte, depending on their chemical reactions and performance characteristics. Some categories of electrolytes suitable for electric vehicle batteries are: solid, liquid, gel, or ionic liquid. Some possible solid electrolytes suitable for electric vehicle batteries are: lithium phosphorus oxynitride, lithium lanthanum zirconate, garnet-type lithium ion conductor, perovskite-type lithium ion conductor, sulfide-type lithium ion conductor, polymer-inorganic composites, and ceramic-polymer composites. Some possible liquid electrolytes suitable for electric vehicle batteries are: organic solvents such as ethylene carbonate, dimethyl carbonate, diethyl carbonate, propylene carbonate, methyl acetate, ethyl acetate, gamma-butyrolactone, acetonitrile, tetrahydrofuran, or a combination thereof; ionic liquids such as imidazolium, pyrrolidinium, ammonium, pyridinium, phosphonium salts, or a combination thereof; and aqueous solutions such as sulfuric acid, potassium hydroxide, sodium hydroxide, zinc chloride, or a combination thereof. Some possible gel electrolytes suitable for electric vehicle batteries are: polyacrylonitrile, polyethylene oxide, polyvinylidene fluoride, polyvinyl alcohol, and polyethylene glycol. Some other possible electrolytes suitable for electric vehicle batteries are: molten salts, air, and redox flow electrolytes.

Current Collectors: The current collectors are the conductive materials that connect the electrodes to the external circuit and allow the flow of electrons in a battery. The current collectors can also serve as mechanical supports for the electrodes and help distribute the current evenly across the electrode surface. Different types of batteries use various materials for the current collectors, depending on their electrical conductivity, corrosion resistance, mechanical strength, and weight. Some possible current collectors suitable for electric vehicle batteries are: copper, aluminum, nickel, stainless steel, carbon, graphite, and their alloys and composites. In the present description, current collectors can also act as electromagnetic wave conduits, which enables dielectric heating of the electrochemical battery to a predetermined temperature suitable for charging. The generated heat can then raise the temperature of the battery. This dielectric heating can be advantageous for charging the battery in cold environments, where the electrochemical reactions are usually slower and less efficient. By heating the battery to a predetermined temperature, the charge acceptance and performance of the battery can be improved. By using the current collectors as electromagnetic frequency wave conduits, the dielectric heating can be focused on the electrochemical cell and minimize negative effects of electromagnetic waves external to the battery. Another benefit is that using the current collectors as electromagnetic wave conduits uses the existing structures of a typical battery rather than requiring modification of the structure of the battery, thus enabling for widespread use of the present method across generally all types of batteries.

Electrolyte Additives: Electrolyte additives are materials that may be added to the electrolyte to improve its performance, stability, and safety in a battery. The electrolyte additives can enhance the formation and maintenance of the solid electrolyte interphase (SEI) layer on the anode surface, which can protect the anode from further degradation and prevent the formation of dendrites. The electrolyte additives can also reduce the decomposition of the electrolyte at high voltages, prevent the oxidation of the cathode, increase the ionic conductivity of the electrolyte, and suppress the flammability of the organic solvents. Different types of batteries use various electrolyte additives, depending on their compatibility with the electrodes and the electrolyte. Some possible electrolyte additives suitable for electric vehicle batteries are: lithium salts such as lithium hexafluorophosphate, lithium tetrafluoroborate, lithium bis(trifluoromethanesulfonyl)imide, lithium bis(oxalato)borate, lithium difluoro(oxalato)borate, and lithium trifluoromethanesulfonate; film-forming agents such as vinylene carbonate, fluoroethylene carbonate, ethylene sulfite, propylene sulfite, and cyclohexyl benzene; flame retardants such as trimethyl phosphate, triphenyl phosphate, dimethyl methylphosphonate, and halogenated hydrocarbons; antioxidants such as ascorbic acid, butylated hydroxytoluene, tert-butylhydroquinone, and phenothiazine; ionic liquids such as imidazolium, pyrrolidinium, ammonium, pyridinium, and phosphonium salts; and nanoparticles such as alumina, silica, titania, and carbon nanotubes.

Separator: A separator may be included in batteries to separate the anode and cathode in a battery cell and prevents direct electrical contact between them. The separator allows the passage of ions through its pores, which enables the electrochemical reactions to occur. The separator may also block the migration of metal dendrites preventing short circuiting. Different types of batteries use various materials for the separator, depending on their compatibility with the electrodes and the electrolyte. Some possible separator materials suitable for electric vehicle batteries are: polyolefins such as polyethylene and polypropylene, ceramics such as alumina and titania, glass fibers, cellulose, and composites of multiple materials, such as polymers, metals, ceramics, and glass. The separator can have different thicknesses, shapes, and sizes.

Cell Enclosure: The cell enclosure is one or more components that surround and protect the electrodes, electrolyte, separator, and current collectors in a battery cell. The cell enclosure can prevent the leakage of a liquid electrolyte, the intrusion of moisture, oxygen, or impurities, and the deformation or damage of the cell due to mechanical, thermal, or electrical stresses. The cell enclosure can also provide electrical insulation and thermal management for the cell. The cell enclosure can have different shapes and sizes, depending on the type of the battery cell. Some common types of cell enclosures are cylindrical, prismatic, and pouch form factors. The components of the cell enclosure can be made of various materials, such as metals, plastics, or composites. The cell enclosure may include one or more layers of different materials, such as metal foils, plastic films, or composite sheets. The layers can have different functions, such as providing mechanical strength, electrical insulation, thermal conductivity, moisture barrier, or electromagnetic shielding. The cell enclosure may also have vents or valves to allow the release of gas or pressure in case of an abnormal event. The shape and size of the cell enclosure may vary depending on the type and configuration of the cell. Cylindrical cells may have a metal can with a cap and a base, prismatic cells may have a metal or plastic case with end plates, and pouch cells may have a flexible polymer laminate pouch with tabs for electrical connection.

Battery Modules: A battery module is a group of battery cells that are connected in series, parallel, or a combination of both to provide the desired voltage, capacity, and power output. A battery module can also include other components, such as bus bars, fuses, sensors, balancing circuits, and cooling plates. The purpose of a battery module is to increase the energy and power density of the battery system, as well as to enhance the safety, reliability, and performance of the individual cells.

Battery Pack: A battery pack is a collection of battery modules that are assembled together to form a larger and more complex energy storage system. A battery pack can also include other components, such as a structural frame, electrical connectors, a thermal management system (TMS), and a battery management system (BMS). The purpose of a battery pack is to provide the required energy and power for the electric vehicle (EV) application, as well as to ensure the safety, durability, and efficiency of the battery system.

Electromagnetic Wave Energy Absorption Sub-Structures: These are additional structures that can be added to the electrochemical cell, the battery modules, or the battery pack to absorb electromagnetic wave energy during the dielectric heating process. The electromagnetic wave energy absorption sub-structures can enhance the dielectric heating process by increasing the amount of electromagnetic wave energy that is absorbed by the battery components, thereby improving the heating efficiency. The electromagnetic wave energy absorption sub-structures can also reduce the electromagnetic interference and radiation that may be generated by the dielectric heating process, thereby improving the compatibility and safety of the battery system. The electromagnetic wave energy absorption sub-structures can be made of different materials and shapes, such as metal, carbon, polymer, ceramic, or composite materials. The electromagnetic wave energy absorption sub-structures can be attached to the surface or embedded in the interior of the electrochemical cell, the battery modules, or the battery pack, depending on the configuration and integration of the dielectric heating system.

Battery Management System (BMS): A BMS is a system that monitors and controls the operation of the battery pack, such as the state of charge (SOC), state of health (SOH), temperature, voltage, current, and balancing of the cells and modules. The BMS can be integrated into the battery pack or may be a separate component in communication with the battery pack. A BMS can also communicate with other systems in the EV, such as the motor controller and the user interface. The main typical functions of a BMS are to protect the battery from overcharging, overdischarging, overheating, short-circuiting, and other abnormal conditions, to optimize the performance and lifespan of the battery, and to provide information and diagnostics to the user and the vehicle. In an aspect of the present description, the BMS may have information that identifies an optimal frequency at which the electrochemical battery's dielectric loss is above a predetermined threshold. In another aspect, the BMS may have information on the type of electrochemical battery in the electric vehicle, which may be used to determining a frequency at which the electrochemical battery's dielectric loss is above a predetermined threshold.

Battery Temperature Sensors: Battery temperature sensors are devices that measure the temperature of the electrochemical cells, the battery modules, or the battery pack. These temperature sensors can be embedded inside the electrochemical cells, the battery modules, or the battery pack. The sensors can use different technologies, such as thermistors, thermocouples, infrared sensors, or optical fibers. The sensors can provide temperature data to the BMS, which can use it to adjust the charging and discharging parameters.

EV Charging Interface: The charging interface is the component that connects the EV battery to the external power source, such as a charging station. The charging interface can support different charging modes and standards, such as AC or DC charging. The charging interface can communicate with the BMS to optimize the charging process and protect the battery from damage. The charging interface may enable data exchange between the BMS and the charging station. For example, the BMS may have information that identifies an optimal frequency at which the electrochemical battery's dielectric loss is above a predetermined threshold, and the BMS may have information on the type of electrochemical battery in the electric vehicle, and such information may be communicated to the charging station.

EV Primary Charging Circuit: The EV primary charging circuit is responsible for transferring electric power from the charging station to the current collectors within the battery pack through the charging interface. This circuit may comprise various components such as a rectifier, an inverter, a DC-DC converter, and a charger, or a combination of these devices. Additionally, it may include sensors, switches, fuses, relays, and other protection devices to ensure safe and efficient operation.

The EV primary charging circuit can be utilized in the dielectric heating process of the electrochemical battery. In this process, electromagnetic wave energy is applied from the charging station through the charging interface to the current collectors of the electrochemical battery, heating it to a predetermined temperature suitable for charging.

Furthermore, the EV primary charging circuit can also be employed to determine the optimal frequency for dielectric heating. This involves applying electromagnetic wave energy at various frequencies using the charging station's electromagnetic wave generator to identify the frequency at which the electrochemical battery's dielectric loss exceeds a predetermined threshold.

Alternatively, a secondary heating circuit may be used for the steps of determining the frequency and heating the battery. However, an advantage of utilizing the primary charging circuit is that it enables the presently described method to be applied to electric vehicles not originally equipped with a secondary heating circuit. This flexibility enhances the applicability and convenience of the dielectric heating method for a wider range of electric vehicles.

EV Secondary Heating Circuit: A secondary heating circuit is a parallel circuit to the primary circuit that may be included in the electric vehicle to provide heat to the electrochemical battery prior to charging. The secondary heating circuit enables the dielectric heating of the battery without using the primary circuit, which may have advantages in terms of process efficiency and safety. The secondary heating circuit may be connected to the charging interface and the current collectors through the battery pack, which allow the selective application of electrical energy to the battery.

EV Communication Interface: The EV communication interface is a component of the electric vehicle that enables the exchange of information with the charging station. The communication interface may facilitate the identification, authentication, authorization, payment, and control of the charging process. The communication interface may relay the information from the battery management system (BMS) to the charging station, such as the battery state of charge, voltage, current, temperature, and charging preferences. The communication interface may relay information that identifies an optimal frequency at which the electrochemical battery's dielectric loss is above a predetermined threshold or the type of electrochemical battery in the electric vehicle, which may be used to determining a frequency at which the electrochemical battery's dielectric loss is above a predetermined threshold. The communication interface may connect to the charging station through the charging interface using wired protocols. Alternatively, the communication interface may include a wireless communication module that can communicate with the charging station without physical contact.

Other EV Components: Electric vehicles (EVs) include numerous components beyond the primary battery and charging systems that contribute to their overall functionality, efficiency, safety, and user experience. Components include the electric motor, which converts electrical energy from the battery into mechanical energy to drive the vehicle, and the power electronics controller, which manages the flow of electrical energy between the battery, the electric motor, and other components. An onboard charger converts AC power from an external charging station into DC power to recharge the vehicle's battery, while regenerative braking systems capture kinetic energy during braking and convert it into electrical energy, which is then stored back in the battery to improve overall energy efficiency and extend driving range. A vehicle control unit (VCU) coordinates various functions of the EV, processing inputs from different sensors, managing power distribution, and ensuring optimal vehicle performance. Infotainment and connectivity systems enhance the driver and passenger experience by providing entertainment, navigation, and connectivity features, including advanced driver assistance systems (ADAS) for improved safety. Sensors and actuators monitor and control various aspects of the EV's operation, including position, temperature, and speed sensors, along with actuators that execute commands from the VCU. Suspension and chassis systems ensure structural integrity, handling, and ride comfort, while auxiliary power systems provide electricity to non-propulsion components such as lights, climate control, and power steering. Vehicle interior components, such as seats, upholstery, and climate control systems, enhance occupant comfort and safety. Additionally, safety systems, including airbags, anti-lock braking systems (ABS), electronic stability control (ESC), crash sensors, and reinforced passenger compartments, are designed to protect occupants and other road users. A conventional Thermal Management System (TMS) is generally included to regulate the temperature of the battery, motor, and other critical components, ensuring optimal performance and longevity.

### Charging Station Components

Power Supply: A power supply is the source of electricity that feeds the charging station. It can be either AC (alternating current) or DC (direct current), depending on the type and design of the charging station. AC power is typically supplied by the utility grid or a renewable energy system, such as solar panels or wind turbines. DC power can be generated by converters, inverters, or batteries. The power supply determines the voltage and current levels that are delivered to the vehicle's battery during charging. The power supply also has safety features, such as circuit breakers, fuses, and surge protectors, to prevent electric shocks, overheating, or short circuits.

Electromagnetic (EM) Wave Generator: an electromagnetic (EM) wave generator is a component of the charging station responsible for producing electromagnetic wave energy. This energy is utilized in the dielectric heating process of the electrochemical battery within electric vehicles (EVs) at specified frequencies. The generator also generates electromagnetic waves at various frequencies, allowing the charging station to determine an optimal frequency at which the electrochemical battery's dielectric loss is maximized. The EM wave generator can operate within frequency ranges suitable for inducing dielectric heating efficiently and safely.

The EM wave generator is a significant feature of the charging station that enables faster and more efficient charging of the electric vehicle's battery. The EM wave generator can include, for example, an oscillator, a modulator, and an amplifier. An oscillator can produce a high-frequency sinusoidal signal that serves as the carrier wave for the EM energy. A modulator modifies the carrier wave by adjusting its amplitude, frequency, or phase, which may depend on data received from the charging station's controller. The data may contain information about the optimal frequency for dielectric heating of the battery, which can vary according to the battery's characteristics, such as chemistry, temperature, and state of charge. An amplifier boosts the power of the modulated signal to a level suitable for transmission. The EM wave generator can dynamically adjust the frequency and power of the EM waves based on the feedback from the charging station's controller, which monitors the battery's temperature, voltage, and current during charging. The EM wave generator allows the charging station to achieve faster charging times, higher energy efficiency, and longer battery life span compared to conventional charging methods.

Charging Cable and Connector: A charging cable and connector are the physical link between the charging station and the charging interface of the electric vehicle. They enable the transfer of power and electromagnetic wave energy between the two devices. The charging cable is a flexible cord that can withstand high voltages, currents, and temperatures. The charging connector is a plug that fits into the vehicle's charging port. Depending on the type and design of the charging station, the charging cable and connector can be either fixed or detachable. Fixed cables and connectors are permanently attached to the charging station and cannot be removed. Detachable cables and connectors can be unplugged from the charging station and stored separately.

Charging Station Primary Charging Circuit: A charging station primary charging circuit is the component of the charging station primarily responsible for delivering power from the power supply to the charging cable and connector. The primary charging circuit may regulate the voltage, current, and frequency of the power output according to the requirements of the electric vehicle's battery and the charging station's controller. The primary charging circuit can also provide electrical isolation and protection against short circuits, overloads, and surges. The primary charging circuit may include, for example, a transformer, a rectifier, a filter, and a switch. A transformer converts the alternating current (AC) input from the power supply to a lower or higher voltage level. A rectifier converts the AC voltage to a direct current (DC) voltage. A filter smooths out the ripple in the DC voltage and reduces noise. A switch controls the on/off state of the power output and can be manually or automatically operated. The primary charging circuit enables the charging station to supply power to the electric vehicle's battery in a safe and efficient manner.

Charging Station Secondary Heating Circuit: A charging station secondary heating circuit is the component of the charging station for delivering electromagnetic wave energy to the charging cable and connector for dielectrically heating the battery. The secondary heating circuit may generate and transmit electromagnetic waves of a specific frequency and intensity to the charging cable and connector. The electromagnetic waves induce an oscillating electric field inside the battery, which heats up the battery's electrolyte and electrodes by dielectric loss. The secondary heating circuit can also adjust the frequency and intensity of the electromagnetic waves according to the feedback from the charging station controller and the communication interface. The secondary heating circuit may include, for example, an oscillator, an amplifier, a modulator, and a coupler. An oscillator produces the electromagnetic waves from an alternating current signal. An amplifier increases the power of the electromagnetic waves. A modulator varies the frequency and intensity of the electromagnetic waves. A coupler transfers the electromagnetic waves from the secondary heating circuit to the charging cable and connector.

Charging Station Switch: A charging station switch is the component of the charging station that allows switching between two modes of operation: power mode and heating mode. In power mode, the switch connects the primary charging circuit to the charging cable and connector, enabling the charging station to supply power to the electric vehicle's battery. In heating mode, the switch connects the secondary heating circuit to the charging cable and connector, enabling the charging station to deliver electromagnetic wave energy to the battery for dielectric heating. The switch may be controlled by the charging station controller based on the charging protocol. The switch can also provide electrical isolation and protection against faults and overloads. The switch may include, for example, a relay, a contactor, or a solid-state device. The switch enables the charging station to alternate between power and heating modes as needed to optimize the charging process and enhance the battery performance and lifespan.

Charging Station Controller: A charging station controller is a component of the charging station that manages and controls the charging process. The charging station controller may communicate with the electric vehicle's battery management system (BMS) via the communication interface to exchange information about the battery's state of charge (SOC), state of health (SOH), temperature, voltage, current, and impedance. The charging station controller may also receive input from sensors and monitors in the charging station and the charging cable and connector. Based on this information, the charging station controller may determine the optimal charging protocol, including the power level, duration, and frequency of power and heating modes. The charging station controller may also adjust the charging protocol dynamically in response to changes in the battery's condition or external factors. The charging station controller may send commands to the switch, the primary charging circuit, and the secondary heating circuit to regulate the power and electromagnetic wave delivery to the battery. The charging station controller may also perform diagnostics, fault detection, and protection functions to ensure the safety and reliability of the charging process. The charging station controller may include, for example, a microprocessor, a memory, a display, and an input device.

The charging station controller may also be responsible for determining and applying the optimal dielectric heating frequency to the battery. The dielectric heating frequency is the frequency of the electromagnetic waves that can induce the maximum dielectric loss and heat generation in the battery's electrolyte and electrodes. The dielectric heating frequency may depend on various factors, such as the battery's chemistry, structure, impedance, temperature, and SOC. The charging station controller may use one or more methods to identify the dielectric heating frequency, such as measuring the battery's impedance response, monitoring the battery's temperature rise, or applying a range of electromagnetic frequencies to the battery and selecting the one that produces the highest power transfer efficiency. The charging station controller may also update the dielectric heating frequency periodically or continuously during the charging process, as the battery's condition may change over time. The charging station controller may send the dielectric heating frequency to the secondary heating circuit, which modulates the electromagnetic waves accordingly. By applying the optimal dielectric heating frequency, the charging station controller can enhance the dielectric heating effect and improve the battery's charging performance and lifespan.

Charging Station Communication Interface: A charging station communication interface is a component of the charging station that may enable and facilitate communication with the electric vehicle's communication interface. The charging station communication interface may use wired or wireless communication protocols, such as power line communication (PLC), radio frequency identification (RFID), Bluetooth, Wi-Fi, cellular, or near-field communication (NFC). The charging station communication interface may be integrated with the charging cable and connector, or it may be a separate device that is attached to or embedded in the charging station. The charging station communication interface may, for example, perform the following functions: establishing a connection with the electric vehicle's communication interface and authenticating the vehicle's identity and authorization; exchanging information with the electric vehicle's battery management system (BMS) via the communication interface, such as the battery's state of charge (SOC), state of health (SOH), temperature, voltage, current, impedance, and optimal charging protocol; transmitting commands and signals from the charging station controller to the electric vehicle's BMS, such as the power level, duration, and frequency of power and heating modes, and the dielectric heating frequency; receiving feedback and data from the electric vehicle's BMS, such as the battery's charging status, power transfer efficiency, and temperature rise; providing user interface and user experience features, such as displaying charging information, offering payment options, enabling remote control, and sending notifications and alerts; supporting smart grid functionalities, such as demand response, load management, and vehicle-to-grid (V2G) services. The charging station communication interface may also communicate with other devices or systems, such as the charging station network, the cloud server, the utility grid, or the user's smartphone. The charging station communication interface may use different communication protocols for different purposes.

Besides the components described above, the charging station may also include other components that are not directly related to the dielectric heating process, but may provide additional functions and features for the charging system. Some examples of these components are:
Power Conversion Unit: A power conversion unit is a component of the charging station that may convert the alternating current (AC) power from the utility grid to the direct current (DC) power that is supplied to the electric vehicle's battery. The power conversion unit may also regulate the voltage and current levels of the DC power according to the optimal charging protocol for the battery. The power conversion unit may consist of one or more devices, such as transformers, rectifiers, inverters, converters, filters, and switches. The power conversion unit may be located inside the charging station, or it may be a separate device that is connected to the charging station by a cable. The power conversion unit may also communicate with the charging station controller and the electric vehicle's BMS via the communication interface, and adjust the power output accordingly.
Cooling System: A cooling system is a component of the charging station that may control the temperature of the charging station and its components, such as the electromagnetic wave generator, the secondary heating circuit, the power conversion unit, and the communication interface. The cooling system may prevent overheating and thermal damage of the charging station components, and improve their efficiency and reliability. The cooling system may use air cooling, liquid cooling, or a combination of both methods. The cooling system may consist of one or more devices, such as fans, pumps, radiators, heat exchangers, and pipes. The cooling system may also communicate with the charging station controller and monitor the temperature of the charging station components. The cooling system may activate or deactivate the cooling devices based on the temperature readings and the cooling requirements.
Safety System: A safety system is a component of the charging station that may protect the charging station, the electric vehicle, and the user from potential hazards and risks, such as electric shocks, short circuits, overcurrents, overvoltages, fires, explosions, electromagnetic interference, or unauthorized access. The safety system may consist of one or more devices, such as fuses, circuit breakers, relays, sensors, alarms, locks, and cameras. The safety system may also communicate with the charging station controller and the electric vehicle's BMS via the communication interface, and detect and respond to any abnormal or emergency situations. The safety system may activate or deactivate the power and heating modes, disconnect the charging cable and connector, alert the user and the authorities, and initiate the emergency procedures.

### Method For Charging

Connecting the Charging Station to the Electric Vehicle: The charging station may establish both a physical and a data connection with the electric vehicle. The physical connection allows the transmission of electromagnetic waves and electric power between the charging station and the battery, while the data connection allows the exchange of information and commands between the charging station controller and the battery management system (BMS). The physical connection may be achieved by connecting a charging cable and a connector of the charging station to the charging interface of the electric vehicle. The charging cable and connector may have different specifications depending on the standards and protocols adopted by the charging station and the electric vehicle. The data connection may be achieved by using a communication interface that allows the transmission of signals and data between the charging station and the electric vehicle. The communication interface may use wired or wireless methods, such as power line communication (PLC), radio frequency identification (RFID), Bluetooth, Wi-Fi, or cellular networks. The communication interface may also use different protocols depending on the standards and formats adopted by the charging station and the electric vehicle.

Determining the Temperature of the Battery: The electric vehicle may have one or more sensors that can measure the temperature of the battery, such as thermocouples, thermistors, or infrared sensors. These sensors may be integrated with the battery management system (BMS) or the electric vehicle's onboard diagnostics (OBD) system. The sensors may communicate with the charging station controller or the BMS via the communication interface, and send the temperature readings to them. The charging station controller or the BMS may compare the temperature of the battery with the optimal temperature range for dielectric heating, which may depend on the type, size, and chemistry of the battery. The optimal temperature range for dielectric heating may vary from depending on the battery characteristics and the charging conditions. If the temperature of the battery is below the optimal temperature range for dielectric heating, the charging station controller or the BMS may activate the dielectric heating mode and apply a suitable electromagnetic frequency to the battery. If, during heating, the temperature of the battery is above the optimal temperature range for dielectric heating, the charging station controller or the BMS may deactivate the dielectric heating mode and stop applying the electromagnetic frequency to the battery. The optimal temperature range for dielectric heating may vary from 30° C. to 200° C., with a preferred range of 40° C. to 100° C.

Dielectric Loss: Dielectric loss is the phenomenon of dissipating electromagnetic energy as heat in a dielectric material when it is subjected to an alternating electric field.

Dielectric loss occurs because the electric dipoles in the material are not able to align perfectly with the applied electric field, due to factors such as inertia, friction, and relaxation effects. The dielectric loss of a material depends on the frequency of the applied electric field, as well as the composition and structure of the material. A higher dielectric loss means that more electromagnetic energy is converted into heat, which can be used for heating purposes.

Determining a Dielectric Heating Frequency: The charging station controller or the BMS may also determine a frequency at which the dielectric loss of the energy storage system is above a predetermined threshold, which may enhance the heating efficiency and reduce the charging time. The dielectric loss of the energy storage system may depend on the frequency of the applied electromagnetic waves, the composition and structure of the battery materials, and the state of charge and state of health of the battery. The charging station controller or the BMS may use a variety of methods to identify a suitable dielectric heating frequency. In an example, a range of electromagnetic frequencies may be applied to the battery using the electromagnetic (EM) wave generator of the charging station, and measuring the temperature change and the power consumption of the battery at each frequency. The charging station controller or the BMS may select the frequency that causes the highest temperature increase and the lowest power consumption of the battery, indicating a high dielectric loss and a high heating efficiency. In another example, the charging station may receive information that identifies an optimal frequency at which the electrochemical battery's dielectric loss is above a predetermined threshold from the electric vehicle, which may be received via the communication interface. The electric vehicle may have a memory device that stores the optimal frequency for dielectric heating based on the battery specifications and performance data. In another example, the charging station may receive information on the type of electrochemical battery in the electric vehicle, which may be received via the communication interface, and the charging station may use a database or a lookup table that associates different types of batteries with different frequencies for dielectric heating. The database or the lookup table may be stored in the memory of the charging station controller or the BMS, or accessed from a remote server via a network connection. The charging station controller or the BMS may use the information on the battery type to retrieve the corresponding frequency for dielectric heating from the database or the lookup table.

Applying a Range of Electromagnetic Frequencies to the Battery: To determine a frequency at which the dielectric loss of the energy storage system is above a predetermined threshold, the charging station may apply a range of electromagnetic frequencies to the battery. The range may be predefined or adjustable by the charging station. The range may be selected based on the type and characteristics of the battery. For example, charging station may divide the range into smaller intervals, which may vary in size depending on the accuracy and speed of the frequency selection process. Then, the charging station may use the electromagnetic wave generator of the charging station to apply each frequency interval to the current collectors of the battery. The electromagnetic wave generator may be able to generate and transmit electromagnetic waves with different frequencies, amplitudes, and waveforms to the battery.

Alternatively, another electromagnetic wave generator, such as one located at the point of manufacture, may be used for this purpose and the dielectric heating frequency may be determined such at the point of manufacture or in another setting.

Dielectric Loss Threshold: The dielectric loss threshold is a minimum value of the dielectric loss that indicates a suitable frequency for dielectric heating of the battery within the selected frequency range. The dielectric loss threshold may be defined in different ways, depending on the type and characteristics of the battery, the desired heating rate and uniformity, and the power consumption and efficiency. Some ways to define the dielectric loss threshold are:

A fixed value of the dielectric loss within the applied frequency range. For example, the dielectric loss threshold may be 0.5%, which means that the charging station will select the frequency that causes the dielectric loss of the battery to be at least 0.5%. Alternatively, the dielectric loss threshold may be set at a higher amount, such as 1%, 2%, 3%, 4%, or 5%.

A relative percentage of the maximum dielectric loss within the applied frequency range. For example, the dielectric loss threshold may be 50% of the maximum dielectric loss within the applied frequency range, which means that the charging station will select the frequency that causes the dielectric loss of the battery to be at least half of the maximum dielectric loss within the applied frequency range. Alternatively, the dielectric loss threshold may be set at a higher amount, such as 60% of the maximum dielectric loss, or 70%, 80%, 90%, or 95% of the maximum dielectric loss.

A combination of the above criteria, such as a fixed value or a relative percentage of the dielectric loss with an upper or lower bound on the frequency. For example, the dielectric loss threshold may be 0.5% or 50% of the maximum dielectric loss within the applied frequency range, whichever is higher, or preferred combination of the dielectric loss or percentage of the maximum dielectric loss.

The dielectric loss threshold may be predetermined by the charging station controller or the BMS based on the information on the type of battery in the electric vehicle, or it may be dynamically adjusted by the charging station controller or the BMS based on the feedback from the temperature sensors or the electromagnetic feedback. The dielectric loss threshold may also vary depending on the environmental conditions, such as the ambient temperature, humidity, and air pressure. The charging station controller or the BMS may use the dielectric loss threshold to identify the optimal frequency for dielectric heating of the battery and apply it to the battery using the electromagnetic wave generator of the charging station.

Range of Electromagnetic Frequencies: A possible range of electromagnetic frequencies that can be applied to the battery may span from 0.1 Hz to 100 GHz, with a preferred range of 1 MHz to 100 GHz, depending on the type and characteristics of the battery. The range of electromagnetic frequencies that can be applied to the battery may depend on various factors, such as the dielectric properties of the battery materials and the safety and regulatory standards for electromagnetic radiation. Therefore, the charging station may adjust the range of electromagnetic frequencies based on the information on the type of battery in the electric vehicle, which may be received via the communication interface. Alternatively, the charging station may scan the entire range of electromagnetic frequencies (e.g., 0.1 Hz to 100 GHz) or a sub-range thereof and select the frequency interval that causes the highest dielectric loss and heating efficiency of the battery. A sub-range of electromagnetic frequencies that may cause the dielectric loss of the battery to be above the dielectric loss threshold may be between 10 MHz and 1 GHz, depending on the type and characteristics of the battery. This sub-range may correspond to the radio frequency (RF) band of the electromagnetic spectrum, which may have advantages such as lower interference with other electronic devices, higher penetration depth into the battery materials, and lower cost and complexity of the electromagnetic wave generator. Another sub-range of electromagnetic frequencies that may cause the dielectric loss of the battery to be above the dielectric loss threshold may be between 1 GHz and 30 GHz, depending on the type and characteristics of the battery. This sub-range may correspond to the microwave band of the electromagnetic spectrum, which may have advantages such as higher heating rate, higher spatial uniformity of heating, and higher control over the heating process. The charging station may measure the dielectric loss response of the battery at each frequency interval and select the frequency interval that causes the highest heating efficiency within the desired electromagnetic frequency range.

Determining the Battery's Dielectric Loss Response to the Electromagnetic Frequencies Applied: The battery's response to the electromagnetic frequencies applied may be determined in order to determine the frequency that causes the highest heating efficiency. In an example, the dielectric loss response may be determined using temperature sensors. The electric vehicle may have temperature sensors that are associated with the battery and can measure the temperature change of the battery at each frequency interval. The temperature sensors may be embedded in the battery pack, attached to the battery terminals, or placed near the battery. The temperature sensors may send the temperature data to the charging station controller or the BMS via a wired or wireless connection. The charging station controller or the BMS may compare the temperature data across different frequency intervals and select the frequency interval that causes the highest temperature increase of the battery, indicating a high dielectric loss and a high heating efficiency.

In another example, the dielectric loss response may be determined using electromagnetic feedback. The electromagnetic feedback from the battery may be determined at each frequency interval. The electromagnetic feedback may include, for example, reflected electromagnetic waves by the battery. The electromagnetic feedback data may be sent to the charging station or the BMS via a wired or wireless connection. The charging station may compare the electromagnetic feedback data across different frequency intervals and select the frequency interval that causes the lowest reflected or transmitted power and the highest absorbed power of the electromagnetic waves by the battery, indicating a high dielectric loss and a high heating efficiency.

Dielectrically Heatable Materials: The battery may include one or more components that are dielectrically heatable, meaning that they can be heated by absorbing electromagnetic wave energy. The dielectrically heatable materials may have a high dielectric loss factor, which indicates the ability of a material to convert electromagnetic wave energy into heat. The dielectrically heatable materials may include any one or more materials of the electric vehicle's battery, for example, the electrolyte, the separator, the binder, the active material, the additives, the current collectors, the terminals, the casing, or any combination thereof. The dielectrically heatable materials may have different dielectric loss responses to different frequencies of the electromagnetic wave energy, as described above. The method may apply a range of electromagnetic frequencies to the battery and measure the dielectric loss response of the dielectrically heatable materials to determine the optimal frequency and duration for heating the battery before charging. During heating, the dielectrically heatable materials of the battery are heated and the heat is migrated to the heat the electrolyte to facilitate charging at cold temperatures.

Applying Electromagnetic Wave Energy to Heat the Battery: Before charging the electrochemical battery, the charging station may apply electromagnetic wave energy to heat the battery to a desired temperature. The electromagnetic wave energy may be applied through the same charging interface that is used to deliver electrical power to the battery, or through a separate interface that is dedicated to heating. The electromagnetic wave energy may have a frequency that is selected based on the dielectric loss response of the battery, as described above. The frequency may be chosen to maximize the heating efficiency. The electromagnetic wave energy may be applied for a duration that is sufficient to raise the temperature of the battery to a predetermined level that is optimal for efficient and safe charging. The duration may depend on various factors, such as the initial temperature of the battery, the ambient temperature, the thermal conductivity of the battery materials, and the power and frequency of the electromagnetic wave energy. The duration may be adjusted dynamically based on the feedback from the temperature sensors or the electromagnetic feedback, as described above. The charging station may stop applying the electromagnetic wave energy when the battery reaches the desired temperature, or when a certain threshold of power consumption or heating efficiency is reached.

### Applying Electrical Power to the Current Collectors: After Heating the Energy

storage system to the desired temperature, the charging station may apply electrical power to the current collectors of the energy storage system to charge the energy storage system. The electrical power may be delivered through the same charging interface that is used to apply the electromagnetic wave energy, or through a separate interface that is dedicated to charging. The electrical power may have a voltage and a current that are suitable for the energy storage system and the charging protocol. The electrical power may be applied for a duration that is sufficient to charge the energy storage system to a predetermined level that meets the user's preference or the vehicle's requirement. The duration may depend on various factors, such as the capacity of the energy storage system, the state of charge of the energy storage system, the power rating of the electrical power supply, and the charging protocol. The duration may be adjusted dynamically based on the feedback from the voltage sensors or the current sensors, as described above. The charging station may stop applying the electrical power when the energy storage system reaches the predetermined level of charge, or when a certain threshold of power consumption or charging efficiency is reached.

As described above, the method of charging of the present disclosure provides several advantages over conventional methods of charging electric vehicles. The method can heat the energy storage system of the electric vehicle to an optimal temperature for efficient and safe charging using electromagnetic wave energy, without relying on external heaters or internal resistive heating. The method can reduce the charging time, extend the battery life, and increase the performance of the electric vehicle. The method can also adjust the frequency, duration, voltage, and current of the applied electromagnetic wave energy and electrical power based on the dielectric loss response, temperature, voltage, and current of the energy storage system, using feedback from sensors or electromagnetic feedback. The method can be implemented using existing charging infrastructure with minor modifications, and can be compatible with various types of energy storage systems and charging protocols.

Although various embodiments of the disclosed method have been shown and described, modifications may occur to those skilled in the art upon reading the specification.

The present application includes such modifications and is limited only by the scope of the claims.

What is claimed is:

1. A method for charging an energy storage system of an electric vehicle using a charging station equipped with an electrical power supply and an electromagnetic wave generator, the method comprising:
connecting the charging station to an electric vehicle;
determining a frequency at which a dielectric loss of the energy storage system is above a predetermined threshold;
applying electromagnetic wave energy at the determined frequency from the electromagnetic wave generator of the charging station to current collectors of the energy storage system to dielectrically heat the energy storage system to a temperature suitable for charging; and
applying electrical power to the current collectors of the heated energy storage system to charge the energy storage system.

2. The method of claim 1 wherein the energy storage system comprises a battery comprising a plurality of electrochemical cells.

3. The method of claim 1 wherein the electrical power supply is a direct current power supply.

4. The method of claim 1 wherein the electromagnetic wave energy is applied to the current collectors at a frequency in the range of 0.1 Hz to 100 GHz.

5. The method of claim 1 wherein the dielectric loss threshold is a dielectric loss of 0.5% or higher.

6. The method of claim 1 wherein the dielectric loss threshold is a dielectric loss of 1% or higher.

7. The method of claim 1 wherein the dielectric loss threshold is a dielectric loss of 2% or higher.

8. The method of claim 1 wherein the dielectric loss threshold is a dielectric loss of 3% or higher.

9. The method of claim 1 wherein the dielectric loss threshold is a dielectric loss of 4% or higher.

10. The method of claim 1 wherein the dielectric loss threshold is a dielectric loss of 5% or higher.

11. The method of claim 1 wherein the dielectric loss threshold is a dielectric loss of 50% or greater of the maximum dielectric loss within the applied frequency range.

12. The method of claim 1 wherein the dielectric loss threshold is a dielectric loss of 60% or greater of the maximum dielectric loss within the applied frequency range.

13. The method of claim 1 wherein the dielectric loss threshold is a dielectric loss of 70% or greater of the maximum dielectric loss within the applied frequency range.

14. The method of claim 1 wherein the dielectric loss threshold is a dielectric loss of 80% or greater of the maximum dielectric loss within the applied frequency range.

15. The method of claim 1 wherein the dielectric loss threshold is a dielectric loss of 90% or greater of the maximum dielectric loss within the applied frequency range.

16. The method of claim 1 wherein the dielectric loss threshold is a dielectric loss of 95% or greater of the maximum dielectric loss within the applied frequency range.
